(19) United States
(12) Patent Application Publication
(10) Pub. No.: US 2002/0074739 A1
(43) Pub. Date: Jun. 20, 2002

(54) Packing set for a rotary shaft and method of making the same

(76) Inventors: Louis J. Mattina, Pittsford, NY (US); Albert L. Harrelson III, Marion, NY (US)

Correspondence Address: Cummings & Lockwood, Granite Square, 700 State Street, P.O. Box 1960, New Haven, CT, 06509-1960, US

(21) Appl. No.: 09/982,590

(22) Filed: Oct. 18, 2001

Related U.S. Application Data
(60) Provisional application No. 60/241,291, filed on Oct. 18, 2000.

(51) Int. Cl. F16L 21/05

(52) U.S. Cl. 277/603

(57) ABSTRACT

A packing set is disclosed for use with pumps, mixers, valves and agitators having a rotary shaft, the packing set including a upper end ring, a lower end ring and a plurality of center sealing rings. The plurality of center rings are disposed between the upper end ring and the lower end ring and axially aligned with respect thereto. Each center ring has a body portion defined by an inside diameter and an outside diameter and is formed from a material which comprises a base rubber and at least about 25 percent by weight fluorine.

### CROSS-REFERENCE TO RELATED APPLICATIONS

This application claims priority to U.S. Provisional Patent Application Serial No. 60/241,291, filed Oct. 18, 2000, which is herein incorporated by reference in its entirety.

### BACKGROUND OF THE INVENTION

1. Field of the Invention

The subject invention relates to rotary shaft packing sets for use in applications such as pumps, mixers, agitators and valves, and more specifically, to the geometric configuration and materials of construction for such packing sets.

2. Background of the Related Art

Stuffing box packing sets for sealing moving shafts are well known in the art. In general, they are used both as a fixed bearing and to prevent leakage in a stuffing box. Stuffing boxes are commonly employed with reciprocating shafts such as piston rods and rotating shafts such as valve stems.

Packing rings are typically formed from materials that have a capacity to prevent leakage, are non-abrasive and have a low coefficient of friction. Rotary shaft packing sets composed entirely (or in part) of rubber-based compounds have been successfully used on a limited basis in pumps, mixers and agitators, for a number of years. However, success has been generally limited to applications that combine slow shaft rotational speeds with ambient to moderate media temperatures. Typical rotational shaft speeds would be less than 100 fpm (feet per minute).

The primary limiting factor for these elastomer seals is temperature related. Rotary shaft seals can become heated in either of two ways—from high temperature media exposure, and/or from the frictional heat that is generated as a result of the sealing contact with the rotary shaft. Depending upon the rubber compound used and the shape/complexity of the seal, over-heated rubber components will exhibit damage from melting, extrusion, softening, cracking, or hardening. In all of these cases, the resultant weight/volume loss will lead to seal failure. This temperature/shaft speed limitation places the use of rubber seals outside of the functional range of most industrial rotary applications.

Due to these temperature limitations, the majority of rotary sealing applications use either compression packing braids or mechanical seals. Composed of interwoven fibrous materials or compressed carbon/graphite or metallic elements, these types of seals can withstand the temperatures that are commonly experienced in the majority of industry rotary services. Commonly owned U.S. Pat. Ser. No. 5,806,858 to Harrelson III, which is herein incorporated by reference, discloses a more recent example of a stuffing box packing assembly for valve stems, shafts and piston rods. The packing is a five-ring assembly consisting of three nested graphite rings of equal size rigidly supported between two braided anti-extrusion end rings. The graphite rings are die-formed from flexible graphite tape and have a density of about 0.5 g/cc to about 1.4 g/cc, and the braided end rings are die-formed from reinforced braided-stock and have a density in excess of 1.8 g/cc. The lower density graphite rings have facing surfaces oriented at a 45 degree angle, and the higher density end rings have facing surfaces oriented at 60. degree. angles, so as to cause the lower density material to flow and expand during installation. Advantageously, the braided end rings, being relatively rigid, are unaffected by the compressive forces applied during packing. They serve as wiper rings to remove particles of graphite from the shaft or valve stem and provide extrusion protection for the packing.

Occasionally, rubber components are incorporated into the body of braided structures to impart enhanced resiliency properties. However, when this is done, the rubber compounds that are typically used are generally not allowed to be in contact with the shaft sealing surface, since temperature exposure remains the primary limiting factor in determining the rubber product's use suitability.

While rubber seal components have not been a viable option for use in most high speed, high temperature service applications, rubber itself has several unique physical attributes that are not associated with other sealing materials. For example, rubber has radial and axial resiliency properties, such as compression and recovery. These properties enable rubber components to readily adapt to shaft misalignment problems, shaft run-out conditions, shaft or box bore variations in surface wear, and stuffing box dimensional variations.

Additionally, rubber may be formed into an impervious conformable body that will conform to the shape and confines of the sealing environment. The only leakage paths that exist when rubber seals are used are along the inner diameter (I.D.) and outer diameter (O.D.) sealing surfaces. No leakage can occur through the body of the component; as compared to the commonly used anti-extrusion rings, where through-the-body leakage is a potential sealing concern.

In view of the foregoing, a need exists for an improved rotary shaft packing set which includes rubber sealing rings that are capable of maintaining seal integrity when used in applications that include high shaft speeds and/or high media temperature.

### SUMMARY OF THE INVENTION

The subject application is directed to rotary shaft packing sets which utilize fluoroelastomer sealing rings having improved wear resistance and sealing performance and a method for making the same. The packing sets are adapted and configured to support and sealingly engage a shaft having a rotational velocity greater than about 100 feet per minute.

In a preferred embodiment, the packing set includes an upper end ring, a lower end ring and a plurality of center rings disposed therebetween. The upper end ring having an inside diameter and an outside diameter which define a ring body portion and an axis for the packing set. The lower end ring also has an inside diameter and an outside diameter which defines a ring body portion.

The center rings are disposed between the upper end ring and the lower end ring and are axially aligned with respect thereto. Similar to the end rings, the center rings have a body portion which is defined by an inside diameter and an outside diameter. In a preferred embodiment, the center rings are formed from a material which includes a base rubber and at least about 25 percent by weight fluorine. The material used to form the center rings may additionally include a laminar solid film lubricant, such as graphite, tungsten disulfide, molybdenum disulfide, lithium stearate hydroxyaluminate, and mixtures thereof.

It is also envisioned that the base rubber used to form the center rings can include a rubber, such as, Nitrile Rubber, Hydrogenated Nitrile Rubber, Styrene Butadiene Rubber, Neoprene, Fluoropolymer. In this embodiment, the composition would have a coefficient of friction lower than about 1.9 and an abrasion resistance of lower than about 125 mg/1000 cycles.

It is further envisioned that the upper and lower end rings are dimensionally relieved. More specifically, the outside diameter of the upper end ring is smaller than the outside diameter of the center rings and the inside diameter of the upper end ring is larger than the inside diameter of the center rings. Additionally, the outside diameter of the lower end ring is smaller than the outside diameter of the center rings and the inside diameter of the lower end ring is larger than the inside diameter of the center rings.

It is presently preferred that the body portion of the center rings have a substantially V-shaped radial cross-section. Alternatively, as would be appreciated by one skilled in the art, the radial cross-section for the center rings can be circular, tubular, square, rectangular, X-shaped, semi-circular or any other geometric shaoe which provides the desired ring flexibly and sealing characteristics. The center rings can also have a hollow cross-section and can be manufactured by an extrusion or molding process. A person skilled in the art can readily appreciate that the number of center rings used in a packing set can vary depending upon the depth of the stuffing box and the desired sealing performance

Preferably, the upper and lower end rings are formed from a material which has a durometer value greater than a durmoeter value for material used to form the at least one center ring. The increased hardness of the end rings relative to the center rings facilitates the application and control of ax axial compressive force to the center rings by a sealing gland.

In a preferred embodiment, the center rings have opposed upper convex and low concave facing surfaces that are inclined at acute angles with respect to the axis of the packing set. Additionally, the upper end ring is a female end ring and has a lower concave facing surface inclined at an acute angle with respect to the axis of the packing set and the lower end ring is a male end ring and has an upper convex facing surface inclined at an acute angle with respect to the axis of the packing set. The configuration of the facing surfaces of the end rings and the center rings facilitates the axial alignment of the packing set and aids in controlling the manner at which compressive forces are applied to the center rings. It is further envisioned that the angle of inclination of the facing surfaces of the center rings differ from the facing surfaces of the upper and lower end rings.

This disclosure also related to a packing assembly for sealing a rotary shaft which includes a housing, a shaft, a seal assembly and a mechanism for applying a compressive force to the seal assembly. The housing defines an elongated cylindrical interior packing chamber or stuffing box and a central axis for the packing set The housing had a bore extending therethrough along the central axis. The shaft is positioned within the central bore of the housing and extends through the housing. The shaft is mounted for rotational movement about an axis which is substantially parallel to the central axis for the packing set. Preferably, the mechanism for applying an axially compressive force to the packing set includes an adjustable sealing gland positioned adjacent to the upper end ring. Alternatively, the mechanism can be a spring biased retainer plate which provides a constant compressive force to the packing set and is not used dependant.

The seal assembly includes an upper end ring, a lower end ring and a plurality of center rings disposed therebetween. The upper end ring having an inside diameter and an outside diameter which define a ring body portion and an axis for the packing set. The lower end ring also has an inside diameter and an outside diameter which defines a ring body portion.

The center rings are disposed between the upper end ring and the lower end ring and are axially aligned with respect thereto. Similar to the end rings, the center rings have a body portion which is defined by an inside diameter and an outside diameter. In a preferred embodiment, the center rings are formed from a material which includes a base rubber and at least about 25 percent by weight fluorine. The material used to form the center rings may additionally include a laminar solid film lubricant, such as graphite, tungsten disulfide, molybdenum disulfide, lithium stearate hydroxyaluminate, and mixtures thereof.

It is also envisioned that the base rubber used to form the center rings can include a rubber, such as, Nitrile Rubber, Hydrogenated Nitrile Rubber, Styrene Butadiene Rubber, Neoprene, Polytetrafluoroethylene. In this embodiment, the composition would have a coefficient of friction lower than about 1.9 and an abrasion resistance of lower than about 125 mg/1000 cycles.

In a preferred embodiment, all of the rings are split rings having a body portion that has a slit that enables the rings to be easily positioned around the shaft and within the stuffing box. The slit provided in the body portion is angled so that the compressive force applied to the packing set effectively closes the slit, forming a continuous sealing ring.

Those skilled in the art will readily appreciate that the inventive aspects of this disclosure are not limited to rotary sealing applications, but can be applied to applications were the relative movement between parts is primarily axial.

### BRIEF DESCRIPTION OF THE DRAWINGS

So that those having ordinary skill in the art to which the present application appertains will more readily understand how to make and use the same, reference may be had to the drawings wherein:

FIG. 1 is a cross-sectional view which illustrates a packing set for sealing a rotary shaft disposed with a stuffing box and constructed in accordance with the present disclosure, the packing set including male and female adapter end rings and five V-shaped center rings;

FIG. 2a is a perspective view of a center ring constructed in accordance with a preferred embodiment of the subject application;

FIG. 2b is a cross-sectional view of the center ring of FIG. 2c taken along line 2b 2b and illustrating the V-shaped cross-section;

FIG. 2c is a top plan view of the center ring of FIGS. 2a and 2b having a V-shaped cross-section;

FIG. 3a is a perspective view of the female adapter end ring constructed in accordance with a preferred embodiment of the subject application;

FIG. 3b is a cross-sectional view of the female adapter end ring of FIG. 3c taken along line 3b -3b;

FIG. 3c is a top plan view of the female adapter end ring of FIGS. 3a and 3b;

FIG. 4a is a perspective view of the male adapter end ring constructed in accordance with a preferred embodiment of the subject invention;

FIG. 4b is a cross-sectional view of the male adapter end ring of FIG. 4c taken along ling 4b -4b;

FIG. 4c is a top plan view of a male adapter end ring;

FIG. 5 is an exploded perspective view of the rotary shaft packing set of the subject disclosure with each ring thereof sectioned to illustrate the geometry thereof;

FIG. 6a is a cross-sectional view of a packing set constructed in accordance with an alternate embodiment of the subject application, illustrating an upper female end ring, a lower male end ring and three center rings disposed therebetween; and

FIG. 6b is a top plan view of the packing set of FIG. 6a.

These and other features of the packing set of the present application will become more readily apparent to those having ordinary skill in the art form the following detailed description of the preferred embodiments.

### DETAILED DESCRIPTION OF PREFERRED EMBODIMENTS

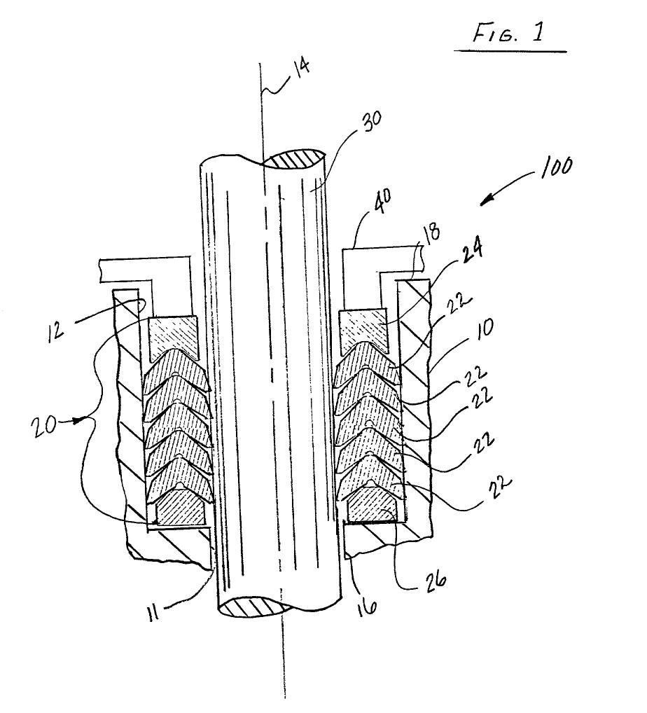

Referring now to the drawings wherein like reference numerals identify similar structural aspects of the subject invention, there is illustrated in FIG. 1 a packing arrangement for sealing a rotary shaft in accordance with an embodiment of the subject application and designated generally by reference numeral 100. Packing arrangement 100 includes a housing 10, a packing set 20 within the housing, a rotary shaft 30 extending through the housing 10, and a sealing gland 40 enclosing the housing 10.

As shown in FIG. 1, housing 10 defines a cylindrical interior packing chamber 12 having a central axis 14. Packing set 20 is disposed between the packing chamber 12 and the shaft 30 and is axially aligned with respect to central axis 14. A bore 11 extends through housing 10. Shaft 30 is disposed with the central bore 11 and extends through housing 10. Shaft 30 is mounted for rotational movement about the central axis 14 for the packing set 20.

In the embodiment disclosed herein, the packing set 20 includes five nested center rings 22, an upper female end ring 24, and a lower male end ring 26. Each ring is aligned with the central axis 14 of the packing set 20, between the shaft 30 and the cylindrical interior wall of the packing chamber 12.

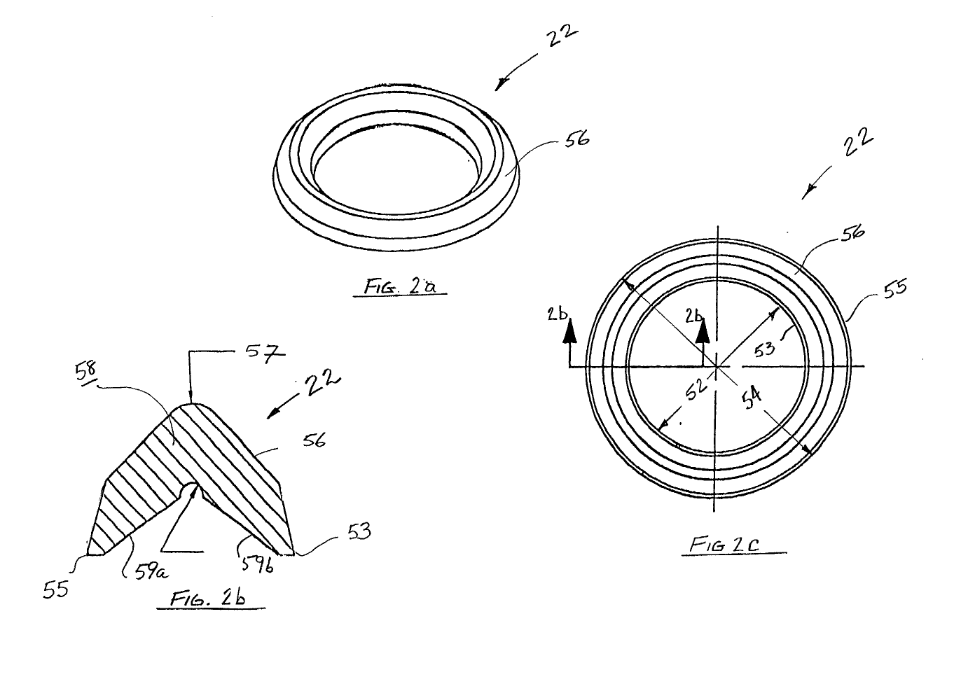

Referring now to FIGS. 2a-2c which illustrate a center ring 22 constructed in accordance with a preferred embodiment of the subject application. Center ring 22 has an inside diameter 52 and an outside diameter 54 which define an inner peripheral surface 53, an outer peripheral surface 55, and a body portion 56. In operation, the body portion 56 functions to provide a seal and prevent fluid from leaking axially from the lower end 16 of housing 10 to the upper end 18.

In the embodiment disclosed herein, the body portion 56 of center ring 22 is formed from a fluorinated rubber, and more specifically, from a material which includes a base rubber and at least about 25 percent by weight fluorine. Also, the body portion has a radial cross-section 58 which is substantially V-shaped. As will be discussed herein below with respect to the specific testing data, the addition of fluorine to the base rubber compound improves the temperature resistance of the center ring and lowers the coefficient of friction of the seal.

Each center ring 22 has been dimensioned and configured to be installed having an interference fit within the packing chamber 12 and the shaft 30. In other words, the center rings 22 contact both the packing chamber 12 and the shaft 30. The overall dimensions can vary depending upon the size of the packing chamber and diameter of the shaft.

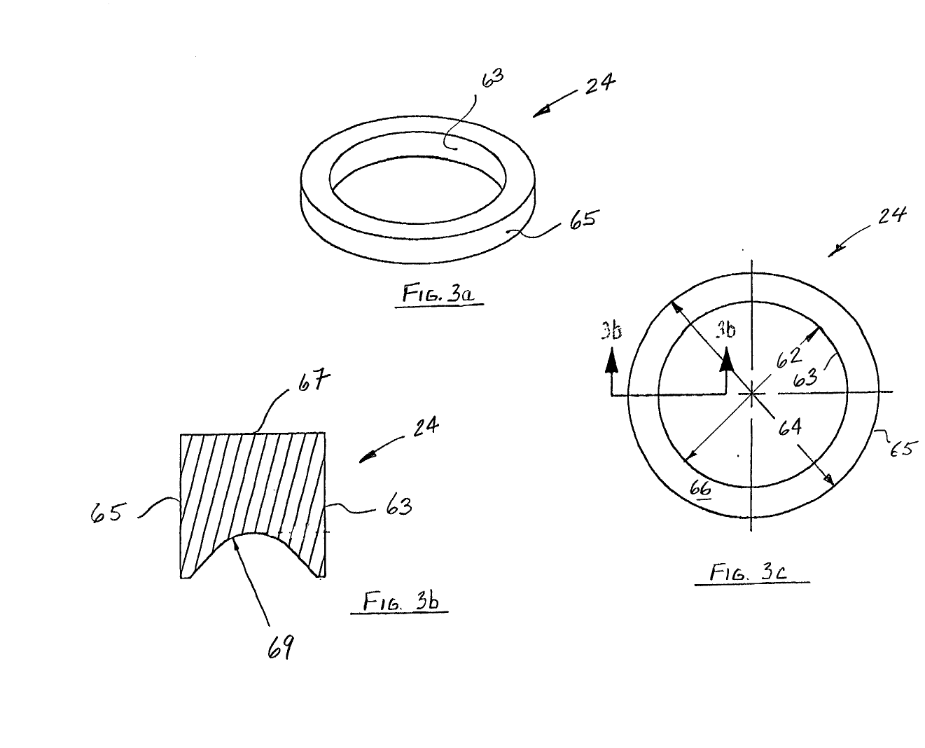

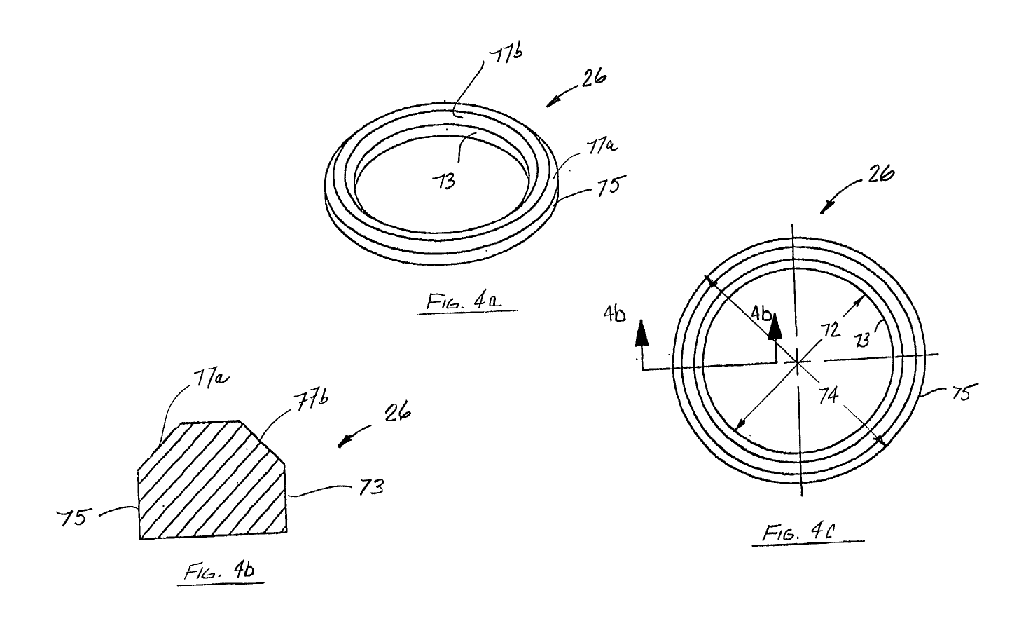

Referring to FIGS. 3a-c and 4a-c, there is illustrated the female and male end rings, 24 and 26 respectively, which are constructed in accordance with a preferred embodiment of the subject invention. As shown in FIG. 1, the end rings 24 and 26 are positioned on axially opposed ends of the center ring stack. Female end ring 24 has an inside diameter 62 and an outside diameter 64 which define an inner peripheral surface 63, an outer peripheral surface 65, and a body portion 66. Male end ring 26 has an inside diameter 72 and an outside diameter 74 which define an inner peripheral surface 73, an outer peripheral surface 75, and a body portion 76.

In the embodiment disclosed herein, both end rings 24 and 26 are formed from a material which has a durometer value that is greater than a corresponding durometer value for material used to form the center rings 22. The increased hardness of end rings 24 and 26 facilitates the application of an axial compressive force to the center rings 22. The increased hardness of the end rings reduces their axial and radial deformation and prevents the end rings from contacting the shaft as a result of the compression As shown in FIG. 1, packing arrangement 100 further includes a gland 40 for applying an axially compressive force to the packing set 20. By selectively applying an axially compressive force to the packing set 20, the V-shaped center rings 22 spread and further increase the interference fit between the center rings 22 and the packing chamber 12 and shaft 30.

It should be noted that the lower male end ring 26 includes angled upper facing surfaces 77a and 77b which are adapted for engaging with facing surfaces 59a and 59b associated with center rings 22. This engagement ensures that the lower male end ring 26 is axially aligned with the center rings. Also, upper female end ring 24, which is positioned on the top of the sealing assembly 20, includes a concave lower facing surface 69 which is adapted for engagement with upper facing surface 57 associated with center rings 22. This ensures the axial alignment of the female end ring 24 with the center rings 22.

In the embodiment shown herein, the facing surfaces of the end rings are not configured at an angle which corresponds to that of the adjacent center ring facing surface. The difference between the facing or mating surface angles of the end rings and the center ring provide for direct loading of the center ring and a predictable stress during packing installation that causes the center rings to undergo a radial elongation or expansion in a controlled manner. This expansion forms an effective seal within the stuffing box or packing chamber 12 and around the shaft 30. The term “packing installation” means during the period that the sealing gland 40 is initially tightened. Those skilled in the art will readily appreciate that other angles than those disclosed in the figures can also be used for the angles of the facing surfaces of the end and center rings in order to achieve a desired predictable stress during packing installation.

Through research, it has been recognized that shaft seals formed from fluoroelastomer or fluoropolymer compounds, having a fluorine content of ≦25%, could perform a stable, near zero-leakage, sealing function at shaft speeds in the range of most industrial pump applications. Successful, long term and stable sealing results have been achieved in pump services at shaft speeds of 2290+fpm when the seals are made from the above-mentioned fluoroelastomer compound.

Testing has also shown that the addition of laminar solid film lubricant powders, flakes, etc. (e.g. graphite, tungsten disulfide, molybdenum disulfide, lithium stearate hydroxyaluminate, etc.) to the fluoroelastomer compound further increases the stability of the sealing performance and service life attributes.

Similar results have been achieved with other rubber compounds (e.g., Nitrile, HNBR, SBR, Neoprene, PTFE, etc.) when the parts are produced from material having a high molecular weight and high viscosity, yielding a product that has, for example:

a. A Coefficient of Friction (ASTM-1894)-1.9 or lower, and

b. Abrasion Resistance (ASTM-4060)-125 mg/1000 cycles or lower.

The above-described compound formulations have exhibited an enhanced degree of abrasive wear resistance, and are almost entirely non-abrasive themselves. Products that have an enhanced degree of wear resistance are usually abrasive to the surfaces with which they are in contact. It has been found that the wear product from the seals made with the above-described compound formulations deposits itself on the shaft and provides an isolated running surface between the shaft and the seal such that the shaft itself is not worn. Hundreds of hours of near zero-leakage sealing contact against non-hardened shafts yielded no score marks on the shaft surface, and little-to-no indication of wear on the sealing component surfaces. This feature further expands the applicability of elastomeric seals to include those rotary services handling abrasive media.

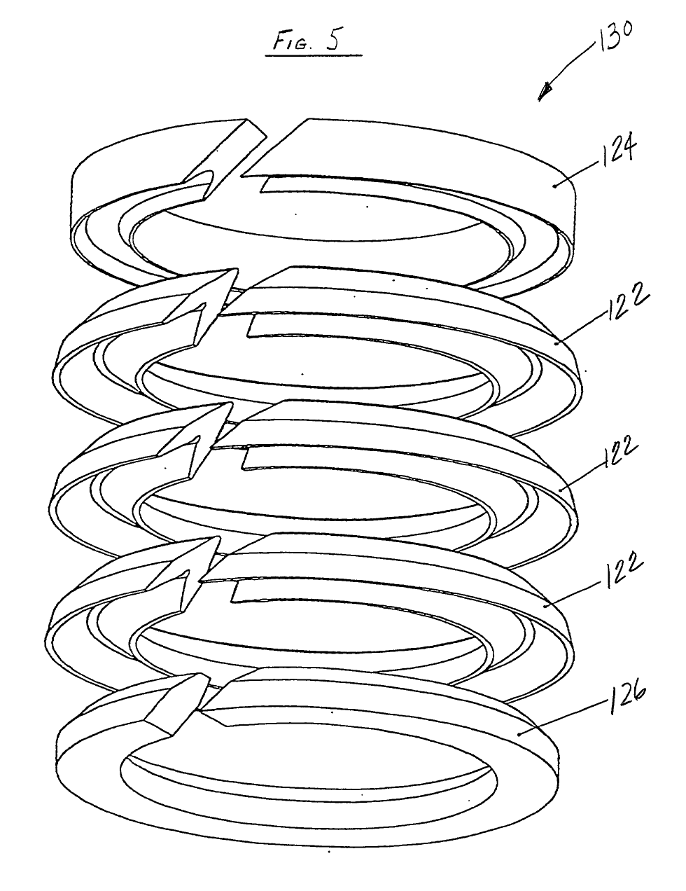

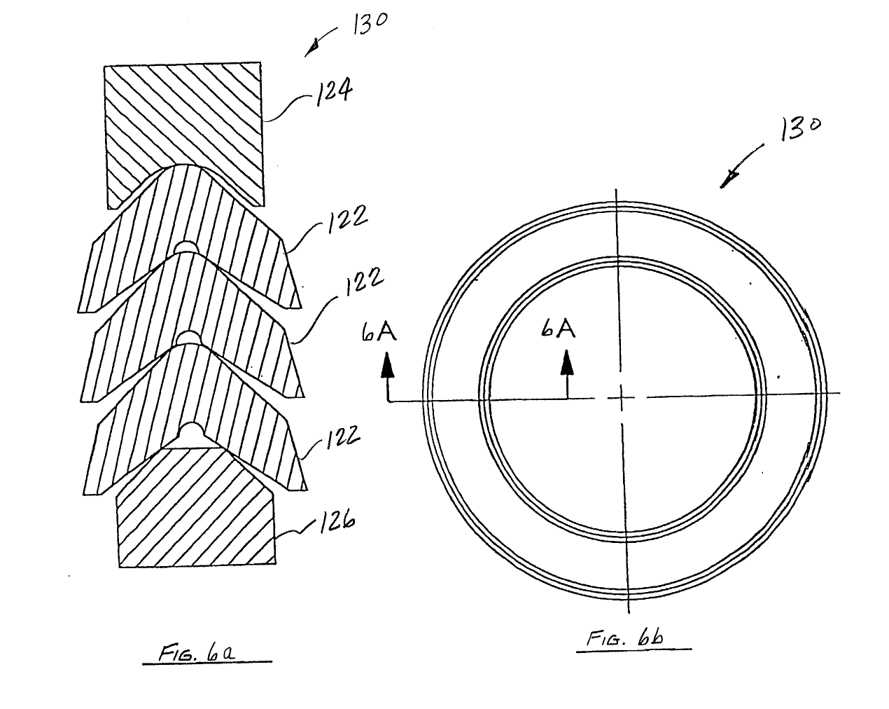

Referring to FIGS. 5, 6a and 6b, there is shown packing set 130 which is similar in structure and function to packing set 30 and common structural elements have been identified by like reference numerals. In contrast to packing set 30, packing set 130 includes only three nested center rings 122 and upper and lower end rings, 124 and 126 respectively. The number of center rings to be used in a specific application is determined based up the desired sealing performance. Additionally, as shown herein, center rings 122 have a radial cross-section which is substantially V-shaped. In alternate embodiments, the radial cross-section can be extruded as a solid round cross-section, a hollow-tube round cross-section, a solid square cross-section, and hollow square cross-section. Alternatively, molded square cross-section ring sets and V-ring sets have been produced as well.

Testing of various cross-sections have shown that while most cross-sections perform satisfactorily, designs that incorporate enhanced flexibility with dimensions yielding an interference fit seem to perform the best. Design examples with an enhanced flexible nature are hollow tube extrusions and molded V-ring sets.

It should be noted that near-zero leakage seals have been achieved with packing sets that contain only a single ring. However, if the shaft 30 is misaligned, or if imperfections exist in the sealing surfaces, such as inner peripheral surface 53, some leakage may get past a single ring-dependent set. Multiple ring sealing component set, as illustrated in FIGS. 1 and 5, offer a degree of built-in sealing redundancy.

In trials conducted on sets with multiple solid extruded rings having a round or square cross-section, it was identified that the first ring sealed so well that the back-up rings suffered an increased degree of frictional heat damage from their dry running condition. These configurations still function at a near-zero leakage rates, are long lived, and cause no shaft damage under any of the sealing components. However, an increased amount of wear did occur under the second sealing component in the set due to the dry running condition.

When multiple ring sets were installed, using hollow tube extrusions or V-ring set components, the above-described wear damage to the back-up rings did not occur. This result demonstrated the advantages of using more flexible components that did not self-apply an increased amount of compressive force against the sealing surfaces. Since the pressure contact of the second (and third) sealing component against the sealing surface was reduced, frictional heat generation from a dry running condition was also correspondingly reduced. With this discovery, multiple sealing component sets were configured to provide built-in sealing redundancy without a corresponding increased degree of wear rate on the back-up ring components of the set.

Designs such as that detailed in FIGS. 1 and 5, which have dimensions yielding an interference fit, ensure that contact is made between the packing set 20 and the shaft 30 and packing chamber 12. Additionally, the enhanced flexibility of these configurations ensure that the radial contact compressive pressure against the contact surfaces is reduced. The flexible nature of these designs also enables the part to be responsively energized by changes in system media pressure, yielding a seal that is self-adjusting. The combined result of these enhancements is the production of a seal that can maintain a stable sealing contact with shaft and packing chamber, while minimizing the frictional heat that is generated.

The use of end-rings on the V-ring sets that are dimensionally relieved on their ID and OD is also disclosed in FIGS. 1 and 5. For example, if the V-ring center rings 22 are produced to dimensions of 1.710″×2.540″ for a 1¾″×2½″ packing chamber, the male and female end rings 26 and 26 may be produced to dimensions of 1.800″×2.450″. It should be noted that the dimensions given herein are for illustrative purposes only and should not be construed to limit or restrict the scope of the subject disclosure. Using adapter end-rings that are dimensionally relieved enables the end-rings to perform a V-ring spreading function, and to still square up the end profiles of the set. However, it prevents them from interfering with the media pressure impact on the V-rings.

Also, if the thickness of the male adapter end-ring is significantly increased, the end-ring (being positioned at the lower end of the stuffing box cavity) can be used to fill excess stuffing box depth space (similar to a bushing ring system). Furthermore, the end-ring can be used to accommodate any surface irregularities in the bottom metal surface of the stuffing box.

It is envisioned that this seal technology may be used to produce and supply low cost, easy installation, rotary sealing sets to compete against the conventional commodity braided product market. The seal configuration and material disclosed herein will be able to be disassembled, repaired and/or replaced, and reassembled on-site with none of the mechanical complications that are presently encountered with seal maintenance.

While the invention has been described with respect to preferred embodiments, those skilled in the art will readily appreciate that various changes and/or modifications can be made to the invention without departing from the spirit or scope of the invention as defined by the appended claims.

What is claimed is:

1. A stuffing box packing set for a rotating shaft comprising:
a) an upper end ring having a body portion defined by an inside diameter and an outside diameter, and having an axis extending therethrough;
b) a lower end ring having a body portion defined by an inside diameter and an outside diameter, and having an axis extending therethrough; and
c) at least one center ring disposed between the upper end ring and the lower end ring and axially aligned with respect thereto and having a body portion defined by an inside diameter and an outside diameter, wherein the at least one center ring is formed from a material which includes a base rubber and at least about 25 percent by weight fluorine.

2. A packing set as recited in claim 1, wherein the material used to form the at least one center ring further comprises a laminar solid film lubricant selected from the group consisting of graphite, tungsten disulfide, molybdenum disulfide, lithium stearate hydroxyaluminate, and mixtures thereof.

3. A packing set as recited in claim 1, wherein the base rubber used to form the at least one center ring comprises a rubber selected from the group consisting of Nitrile Rubber, Hydrogenated Nitrile Rubber, Styrene Butadiene Rubber, Neoprene, Fluoropolymer.

4. A packing set as recited in claim 3, wherein the base rubber has a coefficient of friction lower than about 1.9 and an abrasion resistance of lower than about 125 mg/1000 cycles.

5. A packing set as recited in claim 1, wherein the upper end ring outside diameter is smaller than the outside diameter of the at least one center ring and the inside diameter of the upper end ring is larger than the inside diameter of the at least one center ring.

6. A packing set as recited in claim 1, wherein the outside diameter of the lower end ring is smaller than the outside diameter of the at least one center ring and the inside diameter of the lower end ring is larger than the inside diameter of the at least one center ring.

7. A packing set as recited in claim 1, wherein the body portion of the at least one center ring has a substantially V-shaped radial cross-section.

8. A packing set as recited in claim 1, wherein the body portion of the at least one center ring has a substantially tubular radial cross-section.

9. A packing set as recited in claim 1, wherein the packing set includes at least three center rings.

10. A packing set as recited in claim 1, wherein the packing set includes at least two center rings.

11. A packing set as recited in claim 10, wherein the packing set includes at least seven center sealing rings.

12. A packing set as recited in claim 1, wherein the upper and lower end rings are formed from a material which has a durometer value greater than a durometer value for material used to form the at least one center ring.

13. A packing set as recited in claim 1, wherein the at least one center ring has opposed upper convex and low concave facing surfaces that are inclined at acute angles with respect to the axis of the packing set.

14. A packing set as recited in claim 13, wherein the upper end ring is a female end ring and has a lower concave facing surface inclined at an acute angle with respect to the axis of the packing set and the lower end ring is a male end ring and has an upper convex facing surface inclined at an acute angle with respect to the axis of the packing set.

15. A packing set as recited in claim 14, wherein the angle of inclination of the facing surfaces of the at least one center ring differ from the facing surfaces of the upper and lower end rings.

16. A packing set as recited in claim 1, wherein the packing set is adapted and configured to support and sealingly engage a shaft having a rotational velocity greater than about 100 feet per minute.

17. A packing set as recited in claim 1, wherein the upper end ring, the lower end ring and the at least one center ring are split rings the body portion includes a slit so as to facilitate installation thereof.

18. A stuffing box packing set for a rotating shaft comprising:
a) an upper end ring having a body portion defined by an inside diameter and an outside diameter, and having an axis extending therethrough;
b) a lower end ring having a body portion defined by an inside diameter and an outside diameter, and having an axis extending therethrough; and
c) at least one center ring disposed between the upper end ring and the lower end ring and axially aligned with respect thereto and having a body portion defined by an inside diameter and an outside diameter, the body portion having a substantially V-shaped radial cross-section and is formed from a material which includes a base rubber, a laminar solid film lubricant and at least about 25 percent by weight fluorine.

19. A packing set as recited in claim 18, wherein the laminar solid film lubricant is selected from the group consisting of graphite, tungsten di sulfide, molybdenum disulfide, lithium stearate hydroxyaluminate, and mixtures thereof.

20. A packing set as recited in claim 18, wherein the base rubber used to form the at least one center ring comprises a rubber selected from the group consisting of Nitrile Rubber, Hydrogenated Nitrile Rubber, Styrene Butadiene Rubber, Neoprene, fluoropolymer.

21. A packing set as recited in claim 20, wherein the base rubber has a coefficient of friction lower than about 1.9 and an abrasion resistance of lower than about 125 mg/1000 cycles.

22. A packing set as recited in claim 18, wherein the upper end ring outside diameter is smaller than the outside diameter of the at least one center ring and the inside diameter of the upper end ring is larger than the inside diameter of the at least one center ring.

23. A packing set as recited in claim 18, wherein the outside diameter of the lower end ring is smaller than the outside diameter of the at least one center ring and the inside diameter of the lower end ring is larger than the inside diameter of the at least one center ring.

24. A packing set as recited in claim 18, wherein the packing set includes at least three center rings.

25. A packing set as recited in claim 24, wherein the packing set includes at least five center rings.

26. A packing set as recited in claim 18, wherein the packing set includes at least two center sealing rings.

27. A packing set as recited in claim 18, wherein the upper an d lower end rings are formed from a material which has a durometer value greater than a durometer value for material used to form the at least one center ring.

28. A packing set as recited in claim 18, wherein the at least one center ring has opposed upper convex and low concave facing surfaces that are inclined at acute angles with respect to the axis of the packing set.

29. A packing set as recited in claim 28, wherein the upper end ring is a female end ring and has a lower concave facing surface inclined at an acute angle with respect to the axis of the packing set and the lower end ring is a male end ring and has an upper convex facing surface inclined at an acute angle with respect to the axis of the packing set.

30. A packing set as recited in claim 29, wherein the angle of inclination of the facing surfaces of the at least one center ring differ from the facing surfaces of the upper and lower end rings.

31. A packing set as recited in claim 18, wherein the packing set is adapted and configured to support and sealingly engage a shaft having a rotational velocity greater than about 100 feet per minute.

32. A packing set as recited in claim 18, wherein the upper end ring, the lower end ring and the at least one center ring are split rings the body portion includes a slit so as to facilitate installation thereof.

33. A packing set for sealing a rotary shaft comprising:
a) a housing defining an elongated cylindrical interior packing chamber and a central axis for the packing set, the housing having a bore extending therethrough along the central axis;
b) a shaft positioned within the central bore of the housing and extending through the housing, the shaft being mounted for rotational movement about an axis which is substantially parallel to the central axis for the packing set;
c) a seal assembly which comprises:
i. at least one center ring disposed between the shaft and the cylindrical interior packing chamber and along the central axis for the packing assembly, the at least one center ring having an inside diameter and an outside diameter which define a body portion, the body portion functioning to provide a seal and prevent fluid from leaking axially from one end of the housing to the other, the body portion being formed from a material which comprises a base rubber and at least about 25 percent by weight fluorine;
ii. an upper end ring having a body portion defined by an inside diameter and an outside diameter, and having an axis extending therethrough, the upper end ring being formed from a material which has a durometer value greater than a corresponding durometer value for material used to form the at least one center ring; and
iii. a lower end ring having a body portion defined by an inside diameter and an outside diameter, and having an axis extending therethrough, the lower end ring being formed from a material which has a durometer value greater than a corresponding durometer value for material used to form the at least one center ring; and
d) means for applying an axially compressive force to the packing set.

34. A packing arrangement as recited in claim 33, wherein the material used to form the at least one center ring further comprises a laminar solid film lubricant selected from the group consisting of graphite, tungsten disulfide, molybdenum disulfide, lithium stearate hydroxyaluminate, and mixtures thereof.

35. A packing arrangement as recited in claim 33, wherein the base rubber used to form the at least one center ring comprises a rubber selected from the group consisting of Nitrile Rubber, Hydrogenated Nitrile Rubber, Styrene Butadiene Rubber, Neoprene, Fluoropolymer.

36. A packing arrangement as recited in claim 35, wherein the base rubber has a coefficient of friction lower than about 1.9 and an abrasion resistance of lower than about 125 mg/1000 cycles.

37. A packing set as recited in claim 33, wherein the upper end ring, the lower end ring and the at least one center ring are split rings the body portion includes a slit so as to facilitate installation thereof.
